(19) United States
(12) Patent Application Publication
(10) Pub. No.: US 2025/0377996 A1
(43) Pub. Date: Dec. 11, 2025

(54) Visual Network Hardware Troubleshooting via Multimodal Generative AI

(71) Applicant: Verizon Patent and Licensing Inc., Basking Ridge, NJ (US)

(72) Inventor: Kevin Perkins, Wildwood, MO (US)

(21) Appl. No.: 18/738,166

(22) Filed: Jun. 10, 2024

(51) Int. Cl. G06F 11/273; G06F 11/22

(52) U.S. Cl. CPC G06F 11/2733; G06F 11/2268

(57) ABSTRACT

One or more computing devices, systems, and/or methods for visual troubleshooting a network device setup. Images of the network device setup are provided to the system. A GenAI component processes the images to generate one or more device identifying features. The features are further processed to identify the device. The system utilizes hardware-specific information to prompt the GenAI component to answer troubleshooting-related questions concerning the device setup. The images may be pre-processed to include one or more visual guides to assist the GenAI component.

### BACKGROUND

When a user's network goes down, such as a WiFi network, a user may wish to visually troubleshoot the network hardware setup to determine if it is the cause of the network failure. Often a user may seek the assistance of network provider specialists in performing the visual troubleshooting.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A illustrates an example of an environment that includes a system for visually troubleshooting a network system, in accordance with one or more embodiments of the present technology;

FIG. 1B illustrates another example of an environment that includes a system for visually troubleshooting a network system, in accordance with one or more embodiments of the present technology;

FIG. 2 illustrates an example form of a GenAI prompt utilized in one or more embodiments of a system for visually troubleshooting a network system, in accordance with one or more embodiments of the present technology;

FIG. 3 is a line drawing illustrating an exemplary pre-processed image of a hardware device to be visually troubleshot by a system for visually troubleshooting a network system, in accordance with one or more embodiments of the present technology;

FIG. 4 illustrates an exemplary two-step process for visually troubleshooting network hardware using GenAI, in accordance with one or more embodiments of the present technology;

FIG. 5A is a flow chart illustrating an example method for visually troubleshooting a network system, in accordance with one or more embodiments of the present technology;

FIG. 5B is a flow chart illustrating an example method for performing the troubleshooting task portion of the method shown in FIG. 5A, in accordance with one or more embodiments of the present technology;

FIG. 6 is an illustration of a scenario featuring an example non-transitory machine-readable medium in accordance with one or more embodiments of the present technology;

FIG. 7 is an illustration of a scenario involving various examples of networks that may connect servers and clients in accordance with one or more embodiments of the present technology;

FIG. 8 is an illustration of a scenario involving an example configuration of a server that may utilize and/or implement at least a portion of the techniques presented herein;

FIG. 9 is an illustration of a scenario involving an example configuration of a client that may utilize and/or implement at least a portion of the techniques presented herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

Systems and methods are provided for visual troubleshooting of network hardware. Various types of networks are implemented using hardware components, such as modems, routers, gateways, hubs, switches, and the like. In some embodiments, wireless (e.g., WiFi) networks may be implemented, in part, using modems and wireless routers. When network issues arise and there is a need to perform troubleshooting, a user may visually inspect hardware components of the network setup in order to troubleshoot whether the issues are a result of, or relating to, the hardware. Such users could benefit from an automated visual troubleshooting system or tools that allow for semi-automated visual troubleshooting of network hardware. However, visually troubleshooting a user's network hardware setup in an automated or semi-automated fashion may be hindered from being fully achieved using supervised learning/computer vision due to the open-ended nature of the tasks involved.

Providing images of the hardware setup to visual tools or frameworks (e.g., computer vision and supervised learning tools, models, frameworks, etc.) may allow for an automated or semi-automated approach to troubleshooting. For example, such tools or frameworks may allow for assistants that perform the troubleshooting entirely or that assist a user (e.g., a network user, service provider specialist, etc.) to perform the troubleshooting. However, a number of factors inhibit effective implementation of a wholly or semi-automated visual troubleshooting system. For example, a one-shot artificial-intelligence approach may be inhibited by factors such as model hallucination, poor image quality or selection, poor performance with position encoded georeferencing tasks, etc. Also, for example, computer vision/supervised models may be inhibited by factors such as the open-ended nature and range of the potential issue and tasks involved, poor image quality, user image selection, etc.

The disclosed techniques allow for improved systems (e.g., tools, applications, etc.) for visual troubleshooting of network hardware using multi-modal generative artificial intelligence (GenAI) in one or more components and/or stages. One or more images of the network hardware setup (e.g., internet modem and wireless network router) are uploaded or otherwise provided to the system. In some embodiments, a GenAI component may be configured to process the image(s) to generate (extract) one or more features relating to identifying the hardware. The generated features may then be further processed (by, e.g., one or more components, algorithms, models, etc.) to identify the hardware and/or otherwise assist the further processing in troubleshooting the hardware setup shown in the image(s). In some embodiments, having identified the hardware with the assistance of GenAI, the system may utilize hardware-specific information (e.g., specifications, technical manuals, etc.) to prompt a GenAI component to answer troubleshooting-related questions concerning the one or more images. In some embodiments, the one or more images may be pre-processed to include one or more visual guides to assist the GenAI component.

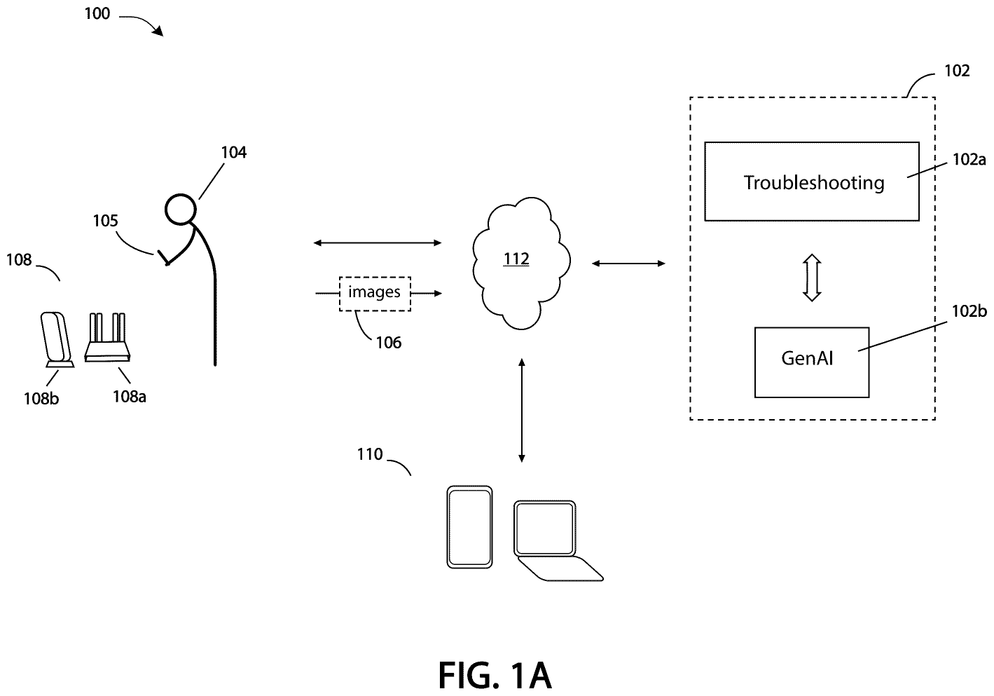

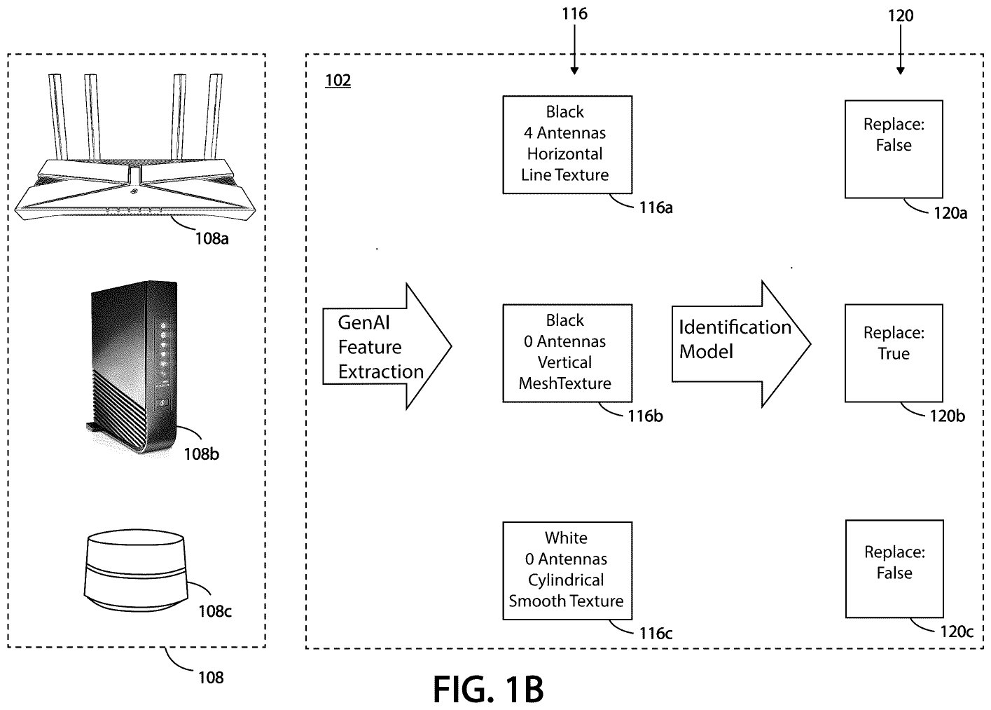

FIGS. 1A and 1B illustrate an example of an environment 100 that includes a system 102 for visual troubleshooting of network hardware using multi-modal generative artificial intelligence (GenAI). In one or more embodiments described herein, troubleshooting system 102 may comprise troubleshooting application 102a and GenAI component 102b. In general, troubleshooting system 102 may be implemented using one or more servers, databases, storages, etc. (not shown), running on one or more computing devices or host machines. Portions of the troubleshooting system 102 may run on one or more client devices, such as mobile device 105 and personal computing devices 110. In some embodiments, the components, portions, etc. of troubleshooting system 102 and implementing servers, databases, storages, etc. may be communicatively coupled via one or more network(s) 112. Network(s) 112 may comprise the internet, intranets, extranets, local area networks (LANs), wide area networks (WANs), wired networks, wireless network (using wireless protocols and technologies such as, e.g., Wifi or cellular), or any other network suitable for providing data communications between two machines, environments, devices, networks, etc. In one or more embodiments, the one or more servers, databases, storages, etc. may be implemented on networked dedicated host machines; in other embodiments, they may be hosted as services in one or more service provider environments. In general, a service provider environment may comprise cloud infrastructure, platform, and/or software providing various servers, databases, data stores, and the like.

With continuing reference to FIG. 1A, in one or more embodiments described herein, troubleshooting system 102 may comprise troubleshooting application 102a and GenAI component 102b. In general, troubleshooting application 102a may comprise one or more software applications, programs, components, models, code portions, scripts, or modules, stores, and the like, that are generally configured to provide backend functionality, server to client functionality, and/or web application functionality, to one or more additional software applications, programs, components, apps, scripts, or modules, and the like (not shown), running on one or more devices (e.g., mobile device 105). Also, in general, troubleshooting system 102 may have any architecture and be configured in any manner sufficient to provide the functionality disclosed herein, including being configured to perform image processing and run one or more trained models for computer vision and feature recognition. For example, one or more trained models (e.g., convolutional neural networks), algorithms, scripts, programs, code, components, etc., pipelined or organized in any suitable manner, may provide the image processing, image localization, object recognition and segmentation, feature and attribute recognition, etc., sufficient to provide the functionality disclosed herein. Similarly, model training may be performed in generally any suitable manner sufficient to provide the functionality disclosed herein. For example, in some embodiments, model training software may be hosted on one or more devices or environments (e.g., system 102) and used to add, revise, update model parameters on the one or more application components after training on new data and data sets, as the case may be.

In some embodiments, troubleshooting system 102 may comprise an identification model, algorithm and/or component configured to identify the make and model of a network hardware device in an image, such as WiFi routers and internet modems, based on a plurality of network hardware device features extracted from the image, as further described below.

In general, GenAI component 102b may comprise one or more multimodal generative artificial intelligence models (e.g., multimodal transformer models) configured to perform and/or capable of being prompted to perform, one or more tasks, including generating one or more insights (e.g. natural language insights) based on one or more files, data structures, streams, etc. containing natural language text, videos, images, etc. In particular, in the embodiments described herein, GenAI component 102b is capable of being prompted to perform one or more tasks in relation to one or more images of network hardware devices, as described in more detail below. GenAI component 102b may run on the same or different computing device, processors, and/or processing environment as troubleshooting application 102a. In some embodiments, the one or more multimodal generative artificial intelligence models of GenAI component 102b may comprise one or more on-premise models and/or one or more connected services provided by, e.g., OpenAI™ (GPT-4o™), Anthropic™ (e.g., Claude 3™), Meta® (MetaCLIP™), Google® (Gemini™), etc.

With continuing reference to FIG. 1A, a user 104 may upload or otherwise make accessible (e.g., by providing source URLs) one or more images 106 of network hardware 108 to troubleshooting system 102, using a client device, such as mobile device 105 or personal computing devices 110. Unless context dictates otherwise, references to “network hardware,” “devices,” and “network devices” may be used interchangeably herein and be understood to mean network modems and/or wireless routers. In some embodiments, user 104 may be prompted by troubleshooting application 102a (e.g., via a connected app, web portal, website, etc.) to upload at least two images showing the front and back of user's relevant network device setup (i.e., user's network device(s) for which visual troubleshooting is desired, as currently deployed by user). In some embodiments, user may be instructed by a human specialist affiliated with the network provider to upload images, and who may be participating with user in a troubleshooting session provided by troubleshooting application 102a.

In some embodiments, troubleshooting application 102a may perform one or more image pre-processing techniques upon receiving or accessing an image provided by a user in a troubleshooting session. In general, any image pre-processing technique suitable to make the image more fit for computer vision processes and/or multimodal generative artificial intelligence feature extraction or other image tasks may be employed in the embodiments herein. For example, some exemplary techniques may include: removing skew, alignment, noise reduction, cropping, resizing, color enhancement or normalization, sharpness (e.g., with respect to any lettering or numbers), etc.

In some embodiments, one or more components may be configured to perform an initial image validation to assess whether the network device in the image has sufficiently clear features in the image to allow for subsequent processing as described below, according to the embodiments disclosed herein. For example, the component may determine whether sufficient angles or views (e.g., front and back) of the network device are shown in the one or more images, whether text, logos or symbols on the network device are sufficiently sharp and defined, etc. In some embodiments, this preliminary validation may not be performed and/or may be performed by the GenAI component, in that the GenAI component may be prompted to include an error or validation check during feature extraction, as described in more detail below. In some embodiments, if the validation determination indicates that the image is insufficient or otherwise unsuitable for sufficient feature extraction, the troubleshooting application may prompt the user for additional images.

In some embodiments, after receiving sufficient image(s), GenAI component 102b may extract one or more identifying features of the network device in the images. In general, any suitable image feature relating to characteristic and/or identifying features of the network device, sufficient to provide the functionality disclosed herein, may be extracted by the GenAI component of the embodiments herein. Also, in general, any suitable manner of configuring or prompting the GenAI component sufficient to provide the functionality described herein may be employed in the embodiments. For example, in some embodiments GenAI component 102b may be prompted with a feature extraction prompt (e.g., natural language prompt) containing instructions to generate descriptions of identifying features of the device in the image. In some embodiments, the feature extraction prompt may contain instructions describing different types or examples of identifying features, such as for example: text on the surface of the device, serial numbers, brand name, model number, antennae count, indicator light count, orientation, shape, surface texture, etc.

FIG. 1B illustrates exemplary identifying feature sets 116a-c, corresponding to features generated by GenAI component 102b, of hardware 108a-c, respectively. In some embodiments, an identification component or model may be configured to identify the hardware device (i.e., return identifying information, such as manufacturer, make, and/or model of the device) based on an identifying feature set (e.g., sets 116a-c). In general, the identification component or model may comprise any suitable software, code, algorithm, model, etc., configured sufficiently to provide the functionality described herein. For example, in some embodiments, the identification component may comprise the same GenAI component (e.g., component 102b) utilized to extract identifying features, or a different GenAI component. In some embodiments, instructions for generating an identification of the network device (e.g., returning a description of the manufacturer, make, and/or model) may be provided to the GenAI component in the same or subsequent prompt as the prompt utilized to prompt the feature extraction. In some embodiments, the feature sets may be returned to the troubleshooting application 102a and one or more functions or trained models may be called to return device identifying information (e.g., manufacturer, make, and/or model) using the feature set as input, arguments, etc.

In some embodiments, troubleshooting system 102 may be configured to determine an upgrade status for the identified device based on the identifying information, wherein the upgrade status comprises an affirmative upgrade status or a negative upgrade status—e.g., a determination whether to upgrade/replace the identified network device or not, as illustrated in FIG. 1B by results 120a-c. In general, the troubleshooting system may be configured in any suitable manner sufficient to provide the upgrade status determination described herein. For example, in some embodiments the troubleshooting application may be configured with a trained upgrade status model, component, code, etc. that returns an upgrade status in response to inputting the identifying information (e.g., as an argument in a function or API call), wherein the model, component, code, etc. may lookup or retrieve the status from one or more curated data sets, tables, etc. In some embodiments, the system may be configured such that a GenAI model or component (not shown) may be prompted to search publicly available or proprietary information or data sets using the identifying information and to generate an upgrade status determination based on factors such as, e.g., whether the device has known issues or problems sufficient to justify an upgrade/replacement recommendation.

In some embodiments, system 102 may be configured to retrieve or access device-specific information for the identified network device and to generate a device-specific troubleshooting prompt using the device-specific information. In general, device-specific information may comprise any suitable device-specific information sufficient to provide the functionality described herein. For example, in some embodiments, device-specific information may comprise user manuals, guides, technical specifications, and the like, or relevant portions thereof, directed to the identified network device. In some embodiments, troubleshooting application 102a may comprise one or more data lakes, data stores, databases, file systems, etc., that store the device-specific information in a manner to be retrieved or accessed by the system using the identification information.

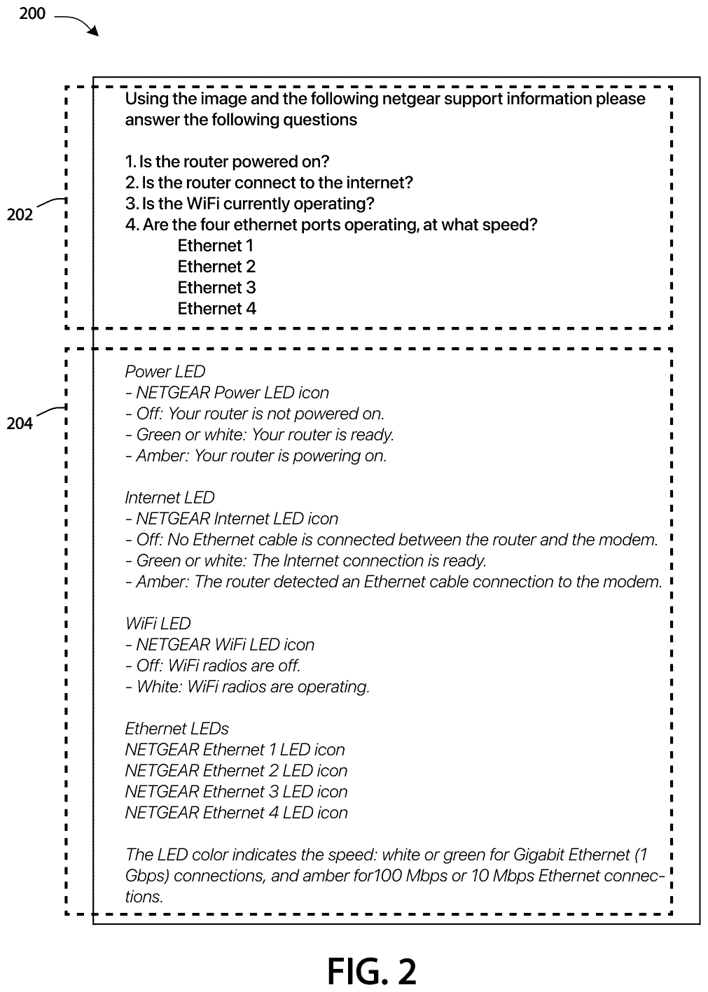

In general, the system may be configured in any suitable manner to generate device-specific troubleshooting prompts, sufficient to provide the functionality described herein. As used herein, unless context dictates otherwise, a device-specific troubleshooting prompt may be understood to mean a generative AI prompt comprising at least one troubleshooting instruction and at least one context that includes device-specific information. In one or more embodiments, the at least one instruction may comprise at least one troubleshooting query. For example, in some embodiments, troubleshooting application 102a may comprise a prompt engine, component, module, code, AI agent, etc. configured to build original device specific troubleshooting prompts, using templates or otherwise, and/or to retrieve previously generated prompts for a particular network device. Note that references herein to accessing or retrieving device specific information and generating device-specific troubleshooting prompts may be understood to include retrieving previously generated and stored troubleshooting prompts for a given network device. While not intended to be limiting, an exemplary form of a device-specific troubleshooting prompt is illustrated by prompt 200 of FIG. 2, which comprises an example troubleshooting instruction 202 and example device-specific information 204, and which reads:

Exemplary Form: Device-Specific Troubleshooting Prompt

```
Using the image and the following netgear support information please
answer the following questions
1. Is the router powered on?
2. Is the router connect to the internet?
3. Is the WiFi currently operating?
4. Are the four ethernet ports operating, at what speed?
  Ethernet 1
  Ethernet 2
  Ethernet 3
  Ethernet 4
Power LED
NETGEAR Power LED icon
Off: Your router is not powered on.
Green or white: Your router is ready.
Amber: Your router is powering on.
Internet LED
NETGEAR Internet LED icon
Off: No Ethernet cable is connected between the router and the modem.
Green or white: The Internet connection is ready.
Amber: The router detected an Ethernet cable connection to the modem.
WiFi LED
NETGEAR WiFi LED icon
Off: WiFi radios are off.
White: WiFi radios are operating.
Ethernet LEDs
NETGEAR Ethernet 1 LED icon
NETGEAR Ethernet 2 LED icon
NETGEAR Ethernet 3 LED icon
NETGEAR Ethernet 4 LED icon
The LED color indicates the speed: white or green for Gigabit Ethernet
(1 Gbps) connections, and amber for100 Mbps or 10 Mbps Ethernet
connections.
```

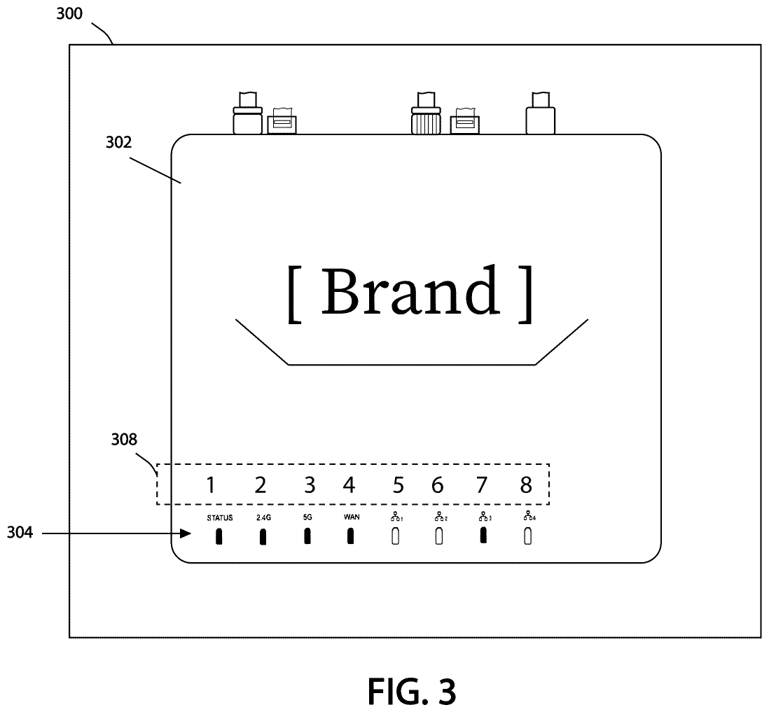

In some embodiments, the system may be configured to add a visual guide to the one or more images provided by the user in order to assist the GenAI component with tasks involving position encoded referencing. For example, with reference to FIG. 3, illustrated is an image 300 of exemplary network hardware 302 (a router). As shown, image 300 has had one or more image processing tasks performed on it by system 102, such as, e.g., alignment, orientation, cropping, and scaling. In addition, as shown, system 102 has added visual guide 308 comprising a row of consecutive numbers, in which each number is aligned with (proximate to) an indicator light on hardware 302. Such visual guides may assist GenAI component 102 perform, for example, such tasks as generating insights relating to specific lights that are present on the surface of the device.

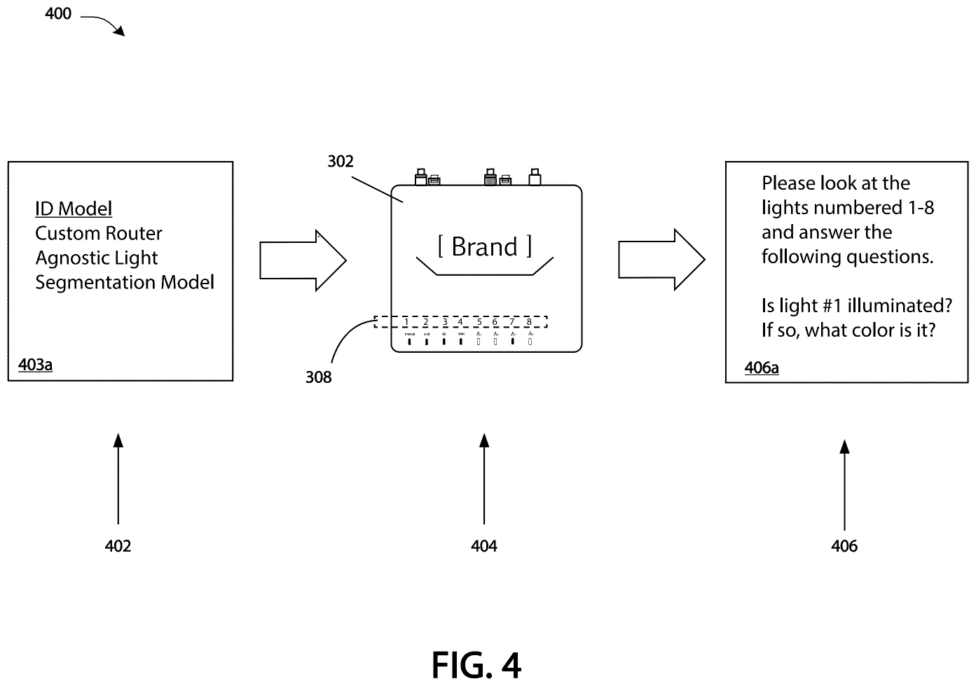

In general, the system may prompt the GenAI component and generate insights in any suitable manner sufficient to provide the functionality herein. In some embodiments, troubleshooting application 102a may prompt GenAI component 102b in the manner of a chat session, and a troubleshooting or other prompt may be provided in one or more sequential calls to the GenAI. In some embodiments, the calls may be handled and responses (i.e., insights) received by the troubleshooting application 102a. For example, in some embodiments, a query (e.g., query 406 of FIG. 4) may provide additional or follow-on instruction to the GenAI component after receiving output or response from a prior prompt, and may be considered to be part of a single troubleshooting prompt as used herein.

In some embodiments, a system component (e.g. troubleshooting component 102a) may be configured to receive and interpret the insights generated by GenAI component 102b. In some embodiments, the system component that receives and interprets the insights may comprise one or more algorithms, code, models, GenAI agents, etc., configured to receive any output insights, interpret the received insights (e.g., make any determination or decisions based on the received insight and any pre-configured troubleshooting workflow, decision-tree algorithms, etc.) and generate a recommendation or report based on the interpreted insight. In some embodiments, the system may be configured to receive the insights and present them to a human operator (e.g., a specialist, via computing device 110) to make the determination and generate a recommendation or report.

In some embodiments, the system may be configured to provide a troubleshooting recommendation or report an error or issue based on the one or more troubleshooting insights. In general, the troubleshooting recommendation or report may be performed in any suitable manner sufficient to provide the functionality described herein. For example, in some embodiments, the system (e.g., system 102) may send a troubleshooting recommendation or issue report via a message to the user's client device (e.g., computing device 105), and/or to a specialist's device (e.g., computing device 110), and/or otherwise makes it available via an application interface, web application, stored entry, etc.

With reference now to FIG. 4, illustrated is a two-step process for visually troubleshooting network hardware using GenAI according to one or more embodiments herein. As shown, at 402 the system (e.g., system 102) has generated a description of characteristic features 402a of the hardware component 302, such as in the manner described above with respect to FIG. 1B. Additionally, at 404 the system has added visual guides 308 to the image (e.g., image 300) useful for generating insights based on performing position encoded referencing. For example, in answering troubleshooting queries relating to position encoded information or features of the hardware (e.g., indicator lights), the visual guides may comprise characteristic numbers 308 aligned with or proximate to each position encoded feature. At 406, the system may be prompted with a troubleshooting query relating to position encoded information, such as troubleshooting query 406a. It may be appreciated that at this stage, the system (e.g., system 102) may have prior device-specific information loaded in the GenAI session from prior prompts identifying the device in question, as described above in relation to FIGS. 1 and 2, and therefore may answer device-specific troubleshooting queries seeking position encoded information, such as troubleshooting query 406a.

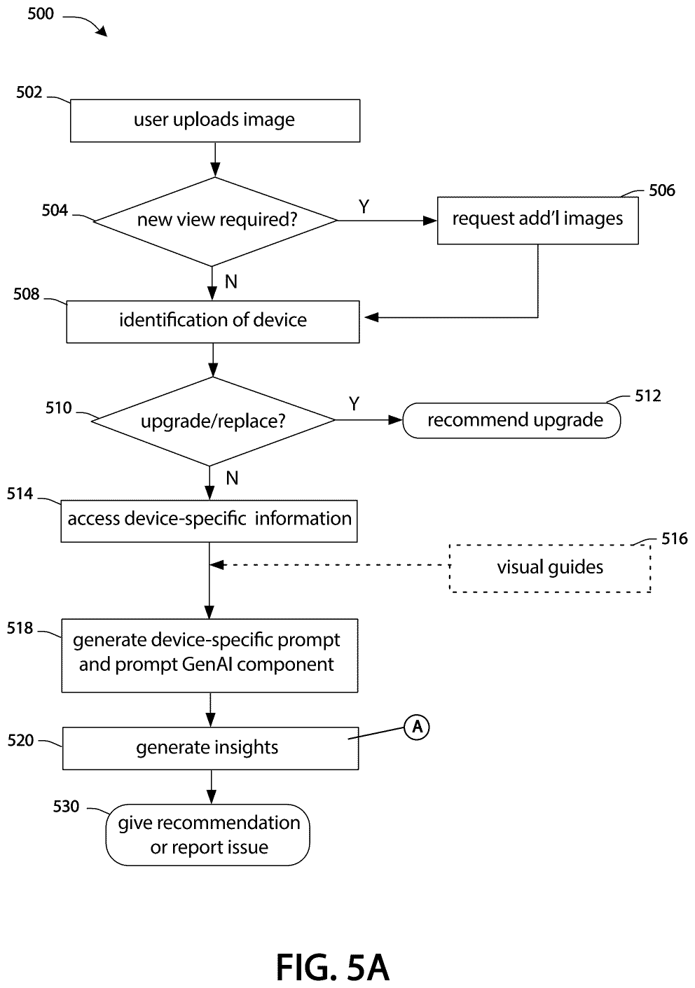

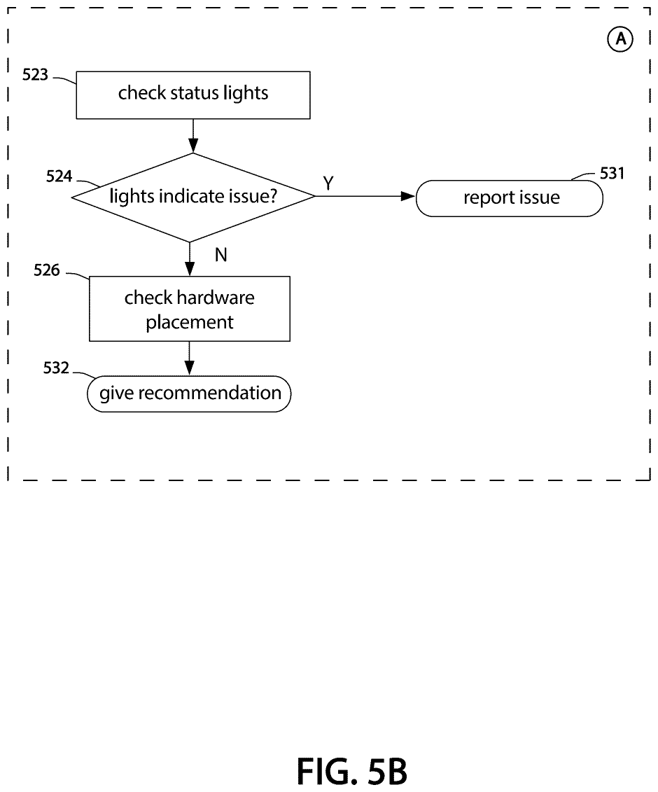

FIG. 5A is a flow chart illustrating an example method 500 for visual troubleshooting of network hardware using GenAI, which is illustrated in connection with exemplary system 102 of FIG. 1A, embodiments of which are further described in relation to FIGS. 1B, 2, 3, and 4.

At 502 a user may provide an image of a network hardware setup to the system. In some embodiments, the system (e.g., system 102) may comprise a component executing on a user's client device (e.g., an app on device 105), and/or otherwise operational in connection with a user's client device (e.g., a web application accessible from client device 105), that is configured to allow for a client to upload and or otherwise send one or more images to the system over a network (e.g., network 112).

At 504 the system may validate or otherwise perform an initial image quality evaluation of the image to determine if the image is insufficient for it to troubleshoot the network hardware setup. In some embodiments, the system may be configured to evaluate such factors as, e.g., empty space (lack of significant features), blurriness, noise, exposure, etc. Note that, in some embodiments, the system may be configured to perform image validation and/or image quality check at one or more later stages and request additional images in response thereto if needed.

If the system determines the provided image to be insufficient for its visual troubleshooting tasks, at 506 the system may indicate to the user (e.g., user 104) that one or more additional images should be uploaded or otherwise provided. In some embodiments, the system may suggest tips for improving the image (e.g., different angle, different lighting, etc.) and/or indicate an error (e.g., exposure, blurriness, etc.).

If the system determines the provided image(s) to be sufficient for its visual troubleshooting tasks, at 508 the system may evaluate the image(s) to determine the identity of the network device shown in the image scene. In some embodiments, a system GenAI component (e.g., component 102b) may be provided with or access the images and may, upon prompting by the system, generate a list of identifying features of the network device shown in the image(s). In general, the GenAI component may be configured/prompted to generate any suitable type of identifying features, output in any suitable data structure/format, sufficient to provide the functionality described herein. For example, with reference to the examples shown in FIGS. 1B and 4, lists 116 and 403 indicate that GenAI component 102b generated a plurality of feature descriptions, in natural language, directed to such characteristics of the evaluated device as, e.g., geometric characteristics of the device, surface characteristics, color of the device, antennae count, model type, etc. In some embodiments, the list of features may be output in, e.g., json, xml, etc., as a list, array, key/value pairs, etc.

In some embodiments, an identification component or model, such as the identification component or model described above in relation to FIG. 1, may then identify the network device based on the set of identification features generated by the GenAI component. In some embodiments, the identification component or model returns device identification information comprising a description of the manufacturer, make, and/or model of the identified device.

At 510 the system may determine an upgrade status for the identified device based on the device identifying information, wherein the upgrade status comprises an affirmative upgrade status or a negative upgrade status—e.g., a determination whether to upgrade/replace the identified network device or not. In general, any suitable criteria and manner of making such determination sufficient to provide the functionality disclosed herein may be utilized. For example, in some embodiments, the troubleshooting application (e.g. application 102a) may be configured with a trained upgrade status model, component, code, etc. that returns an upgrade status in response to inputting the device identifying information from 508 (e.g., as an argument in a function or API call), wherein the model, component, code, etc. may look up or retrieve the status from one or more curated data sets, tables, etc. In some embodiments, the system may be configured such that a GenAI model or component may be prompted to search publicly available or proprietary information or data sets using the identifying information and to generate an upgrade status determination based on factors such as, e.g., whether the device has known issues or problems sufficient to justify an upgrade/replacement recommendation.

If the determination is an affirmative upgrade status, at 512 the system may make a recommendation to replace or upgrade the hardware by, for example, communicating the affirmative determination to the user. In some embodiments, the system (e.g., system 102) may send the determination via a message to the user's client device (e.g., computing device 105), and/or to a specialist's device (e.g., computing device 110), and/or or otherwise make it available via an application interface, web application, stored entry, etc.

If the determination is a negative upgrade status, at 514 the system may retrieve or otherwise access device-specific information for the identified network device. In general, device-specific information may comprise generally any suitable information that is associated with the identified device, stored and accessed in any suitable manner, sufficient to provide the functionality described herein. For example, in some embodiments, device-specific information may comprise user manuals, guides, technical specifications, and the like, or relevant portions thereof, directed to the hardware identified at 508. In some embodiments, device-specific information may comprise, for example, one or more portions of user manuals for the identified hardware that are relevant to the troubleshooting tasks (e.g., generating responses to troubleshooting queries).

At 516, in some embodiments, the system may process the image(s) (e.g., images 106) to add one or more visual guides. In general, visual guides may comprise any suitable visual references added to an image that may assist the GenAI component to perform position-encoded referencing tasks, sufficient to provide the functionality described herein. In some embodiments, the system may be configured to add visual guides to every image. In some embodiments, the system may be configured to add visual guides only to images that meet predefined criteria. For example, in some embodiments, the predefined criteria may comprise that the image shows predefined network hardware (e.g., if the image shows identified hardware that has been flagged or otherwise denoted by the system as requiring visual guides to be added). For example, in some embodiments, the system may be configured to add consecutive numbers to any image of a network device that has indicator lights, such that each of the consecutive numbers is aligned with or proximate to an indicator light (e.g., visual guides 308 aligned and corresponding to indicator lights 304, in FIG. 3).

At 518, the system may generate a troubleshooting prompt that includes device-specific information and prompt (call) the GenAI component using it. In general, a troubleshooting prompt may comprise any suitable GenAI prompt sufficient to troubleshoot the network devices in the manner described herein to provide the functionality described herein. In some embodiments, a troubleshooting prompt may comprise a natural language instruction containing at least one troubleshooting query and context comprising at least a portion of the device-specific information accessed or retrieved at 514 (e.g., prompt 200 of FIG. 2 with instruction 202 and context 204). Note that, in some embodiments, the system may prompt the GenAI component in the manner of a chat session, and a troubleshooting prompt may be posed to the GenAI component sequentially in a back-and-forth manner. For example, a query (e.g., query 406 of FIG. 4) may provide additional or follow-on instruction to the GenAI component after receiving output or response from a prior prompt, and may be considered to be part of a single troubleshooting prompt as used herein.

At 520 the GenAI component (e.g., component 102b) may generate one or more troubleshooting insights. In general, a troubleshooting insight in the embodiments described herein may be an insight generated based on a troubleshooting prompt. For example, in some embodiments, a troubleshooting insight may comprise a natural language response to an instruction query (e.g. troubleshooting query 406a of FIG. 4), wherein the response is based on the instructions and context contained in the troubleshooting prompt.

At 530 the system may provide a troubleshooting recommendation or report an error or issue based on the one or more troubleshooting insights. In general, the troubleshooting recommendation or report may be performed in any suitable manner sufficient to provide the functionality described herein. For example, in some embodiments, the system (e.g., system 102) may send a troubleshooting recommendation or issue report via a message to the user's client device (e.g., computing device 105), and/or to a specialist's device (e.g., computing device 110), and/or otherwise makes it available via an application interface, web application, stored entry, etc.

FIG. 5B is a flow chart illustrating one exemplary troubleshooting routine (e.g., one embodiment of stage 520 in FIG. 5A), in accordance with one or more embodiments described herein. At 523 the system may generate troubleshooting insights based on indicator lights of the identified network hardware in the image (e.g., lights 304 of hardware 302 in image 300). In some embodiments, insights may be generated by the GenAI component (e.g., component 102b), being prompted with one or more queries regarding the indicator lights and device-specific information relevant to the indicator lights.

At 524 the system may determine whether the insights generated concerning the indicator lights at 523 are determinative of an issue with the network hardware setup shown in the image. In general, the system (e.g. system 102) may make the determination in any suitable manner sufficient to provide the functionality described herein. For example, in some embodiments, a system component (e.g. troubleshooting component 102a) may be configured to receive and interpret the insights generated by GenAI component 102b. In some embodiments, the system component that receives and interprets the insights may comprise one or more algorithms, code, models, GenAI agents, etc., of troubleshooting component 102a, for example, configured to receive and interpret the insights and make the determination and generate a recommendation or report. In some embodiments, the system may be configured to receive the insights and present them to a human operator (e.g., a specialist, via computing device 110) to make the determination and generate a recommendation or report.

If the determination is made that the indicator lights are determinative of an issue, and a recommendation and/or issue report has been generated, at 531 the system may provide the recommendation and/or issue report to a user. In some embodiments, the system (e.g., system 102) may send the troubleshooting recommendation and/or issue report via a message to the user's client device (e.g., computing device 105), and/or to a specialist's device (e.g., computing device 110), and/or otherwise makes it available via an application interface, web application, stored entry, etc.

If the determination is made that the indicator lights are not determinative of an issue, or the system fails to make a determination based on the indicator lights, at 526 the system may generate troubleshooting insight based on the placement of the hardware (a hardware placement insight), as shown in the image. For example, the image may show that the hardware may be placed in location that is likely to have significant interference (e.g., if the hardware is a wireless router). In general, the system (e.g. system 102) may generate the hardware placement insight in any suitable manner sufficient to provide the functionality described herein. For example, in some embodiments, the troubleshooting prompt described above at 518 may include instructions and context sufficient for the GenAI component to generate the hardware placement insight. In some embodiments, the system may generate a second troubleshooting prompt that includes instructions and context sufficient for the GenAI component to generate the hardware placement insight and make a second call to the GenAI component using the second troubleshooting prompt.

Having generated a hardware placement insight, in some embodiments a system component (e.g. troubleshooting component 102a) may be configured to receive and interpret the output hardware placement insight from GenAI component 102b. In some embodiments, the system component may comprise one or more algorithms, code, models, GenAI agents, etc., configured to receive the hardware placement insight and generate a recommendation or report. In some embodiments, the system may be configured to receive the hardware placement insight and present it to a human operator (e.g., a specialist, via computing device 110) to make the determination and generate a recommendation or report.

At 532 the system may provide a recommendation based on any hardware placement insight generated or, generating none, report on the lack of troubleshooting success. In some embodiments, the system may provide the recommendation and/or issue report to a user. In some embodiments, the system (e.g., system 102) may send the recommendation and/or issue report via a message to the user's client device (e.g., computing device 105), and/or to a specialist's device (e.g., computing device 110), and/or otherwise makes it available via an application interface, web application, stored entry, etc.

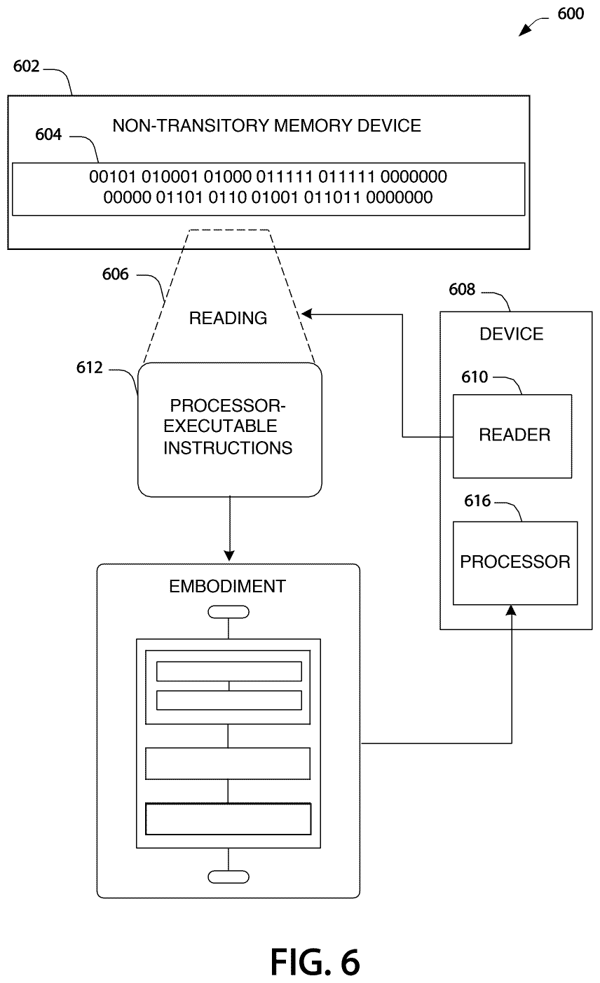

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1.

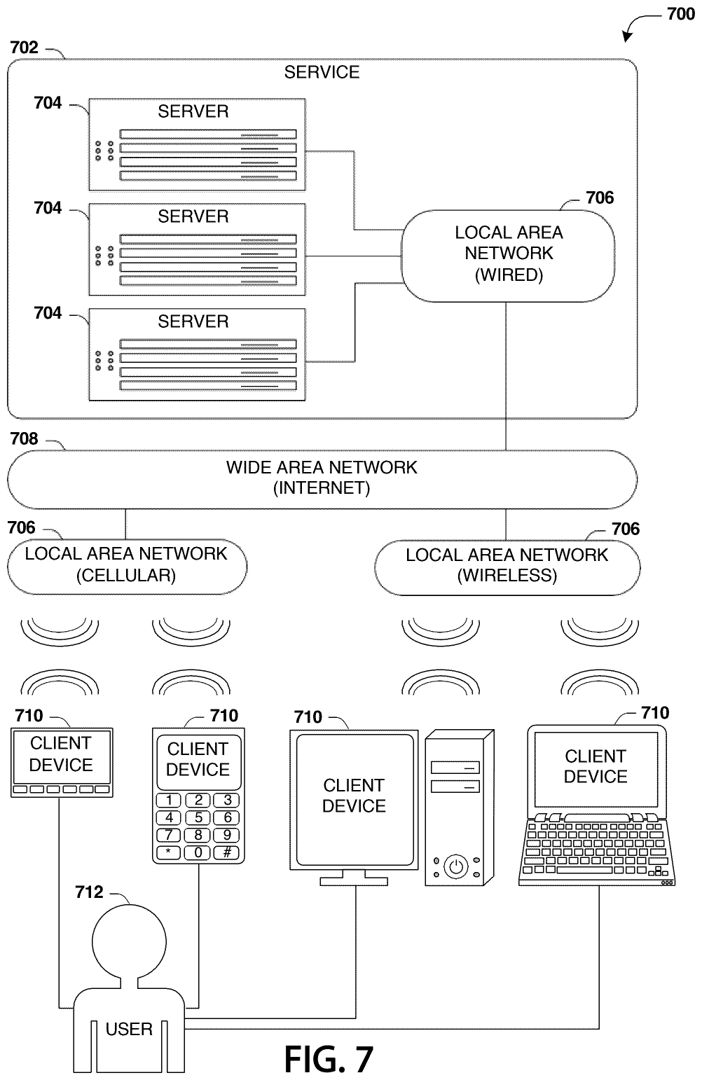

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states. In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

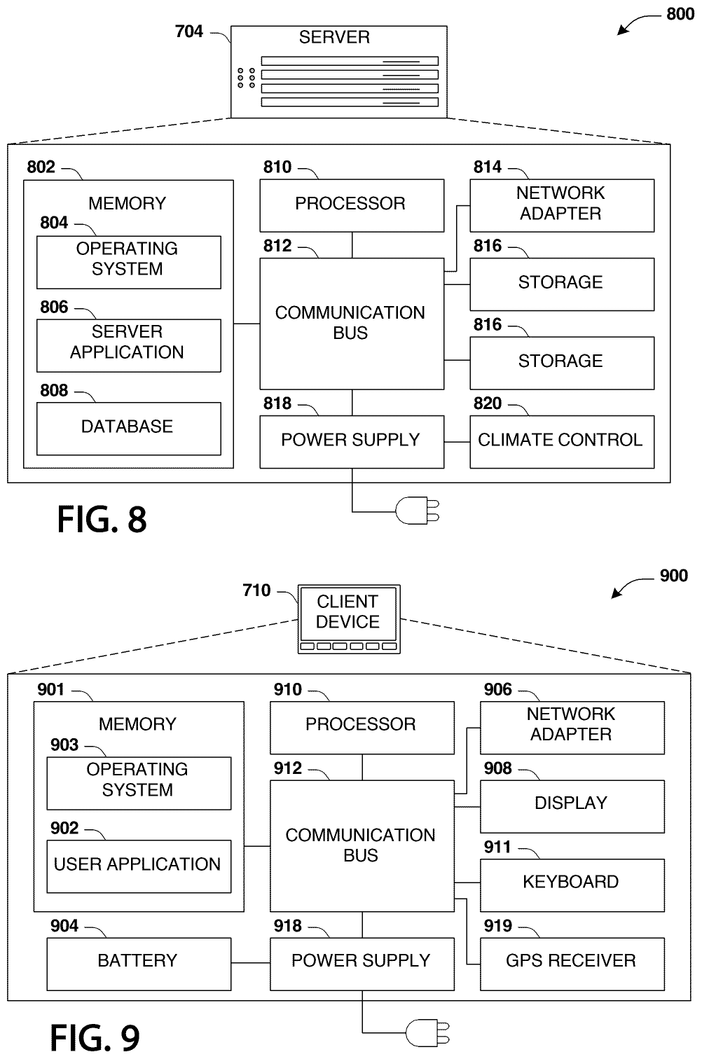

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service. The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” and “exemplary” are used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

1. A method, comprising:
providing a network hardware troubleshooting application comprising a GenAI component;
receiving, from a user client device, by the troubleshooting application, an image of a first scene comprising a network hardware setup comprising a network device;
extracting, by the GenAI component, identifying features of the network device;
determining, by the troubleshooting application, identification information of the network device based on the identifying features;
determining, by the troubleshooting application, whether to replace the network device based on the identifying information, wherein an upgrade status corresponding to the determination of whether to replace the network device comprises an affirmative upgrade status or a negative upgrade status; and
generating, by the troubleshooting application, an upgrade status report if the upgrade status is determined to be an affirmative upgrade status and providing the upgrade status report for display on the user client device.

2. The method of claim 1, comprising:
performing, by the troubleshooting application, a troubleshooting protocol if the upgrade status is determined to be a negative upgrade status, the troubleshooting protocol comprising:
accessing a set of device-specific information based on the identification information;
generating a troubleshooting prompt comprising a troubleshooting query about the network device and the set of device-specific information;
prompting the GenAI component using the troubleshooting prompt;
generating, by the GenAI component, a troubleshooting insight based on the troubleshooting prompt;
generating a first troubleshooting recommendation based on the troubleshooting insight; and
displaying the first troubleshooting recommendation on the user client device.

3. The method of claim 2, wherein the identifying features comprise at least one of a shape, a surface texture, a color, an antennae count, an indicator light count, or an orientation, and wherein device-specific information comprises a portion of at least one of one or more user manuals, one or more guides, or one or more technical specifications directed to the network device.

4. The method of claim 2, wherein the network device has a plurality of indicator lights and wherein the troubleshooting query comprises a query directed to checking the plurality of indicator lights.

5. The method of claim 2 further comprising:
adding, by the troubleshooting application, visual guides to the image to create a modified image.

6. The method of claim 5 wherein the network device has a plurality of indicator lights, wherein the visual guides comprise a set of consecutive numbers, wherein each consecutive number is located proximate one indicator light in the modified image, and wherein the troubleshooting query comprises at least one position encoded question concerning the plurality of indicator lights.

7. The method of claim 6, further comprising:
generating an indicator light insight in response to the at least one position encoded question concerning the plurality of indicator lights;
generating a hardware placement prompt if the indicator light insight fails to indicate an issue;
generating a hardware placement insight in response to the hardware placement prompt;
generating a hardware placement recommendation based on the hardware placement insight; and
providing, to the user client device, the hardware placement recommendation.

8. A computing device comprising:
a processor; and
memory comprising processor-executable instructions that when executed by the processor cause performance of operations, the operations comprising:
receiving, from a user client device, by a network hardware troubleshooting application comprising a GenAI component, an image of a first scene comprising a network hardware setup comprising a network device;
extracting, by the GenAI component, identifying features of the network device;
determining, by the troubleshooting application, identification information of the network device based on the identifying features;
determining, by the troubleshooting application, whether to replace the network device based on the identifying information, wherein an upgrade status corresponding to the determination of whether to replace the network device comprises an affirmative upgrade status or a negative upgrade status; and
generating, by the troubleshooting application, an upgrade status report if the upgrade status is determined to be an affirmative upgrade status and providing the upgrade status report for display on the user client device.

9. The computing device of claim 8, wherein the operations further comprise:
performing, by the troubleshooting application, a troubleshooting protocol if the upgrade status is determined to be a negative upgrade status, the troubleshooting protocol comprising:
accessing a set of device-specific information based on the identification information;
generating a troubleshooting prompt comprising a troubleshooting query about the network device and the set of device-specific information;
prompting the GenAI component using the troubleshooting prompt;
generating, by the GenAI component, a troubleshooting insight based on the troubleshooting prompt;
generating a first troubleshooting recommendation based on the troubleshooting insight; and
displaying the first troubleshooting recommendation on the user client device.

10. The computing device of claim 9, wherein the identifying features comprise at least one of a shape, a surface texture, a color, an antennae count, an indicator light count, or an orientation, and wherein device-specific information comprises a portion of at least one of one or more user manuals, one or more guides, or one or more technical specifications directed to the network device.

11. The computing device of claim 9 wherein the network device has a plurality of indicator lights and wherein the troubleshooting query comprises a query directed to checking the plurality of indicator lights.

12. The computing device of claim 9, wherein the operations further comprise:
adding, by the troubleshooting application, visual guides to the image to create a modified image.

13. The computing device of claim 12, wherein the network device has a plurality of indicator lights, wherein the visual guides comprise a set of consecutive numbers, wherein each consecutive number is located proximate one indicator light in the modified image, and wherein the troubleshooting query comprises at least one position encoded question concerning at least one of the plurality of indicator lights.

14. The computing device of claim 13, wherein the operations further comprise:
generating an indicator light insight in response to the at least one position encoded question concerning the plurality of indicator lights;
generating a hardware placement prompt if the indicator light insight fails to indicate an issue;
generating a hardware placement insight in response to the hardware placement prompt;
generating a hardware placement recommendation based on the hardware placement insight; and
providing, to the user client device, the hardware placement recommendation.

15. A non-transitory computer-readable medium storing instructions that when executed facilitate performance of operations comprising:
receiving, from a user client device, by a network hardware troubleshooting application comprising a GenAI component, an image of a first scene comprising a network hardware setup comprising at least one network device;
extracting, by the GenAI component, identifying features of the at least one network device;
determining, by the troubleshooting application, identification information of the at least one network device based on the identifying features;
determining, by the troubleshooting application, whether to replace the at least one network device based on the identifying information, wherein an upgrade status corresponding to the determination of whether to replace the at least one network device comprises an affirmative upgrade status or a negative upgrade status; and
generating, by the troubleshooting application, an upgrade status report if the upgrade status is determined to be an affirmative upgrade status and providing the upgrade status report for display on the user client device.

16. The non-transitory computer-readable medium of claim 15, wherein the operations further comprise:
performing, by the troubleshooting application, a troubleshooting protocol if the upgrade status is determined to be a negative upgrade status, the troubleshooting protocol comprising:
accessing a set of device-specific information based on the identification information;
generating a troubleshooting prompt comprising troubleshooting query about the at least one network device and the set of device-specific information;
prompting the GenAI component using the troubleshooting prompt;
generating, by the GenAI component, at least one troubleshooting insight based on the troubleshooting prompt;
generating a first troubleshooting recommendation based on the at least one troubleshooting insight; and
displaying the first troubleshooting recommendation on the user client device.

17. The non-transitory computer-readable medium of claim 16, wherein the identifying features comprise at least one of a shape, a surface texture, a color, an antennae count, an indicator light count, or an orientation, and wherein device-specific information comprises a portion of at least one of one or more user manuals, one or more guides, or and one or more technical specifications directed to the at least one network device.

18. The non-transitory computer-readable medium of claim 16, wherein the at least one network device has a plurality of indicator lights and wherein the troubleshooting query comprises a query directed to checking the plurality of indicator lights.

19. The non-transitory computer-readable medium of claim 16, wherein the operations further comprise:
adding, by the troubleshooting application, visual guides to the image to create a modified image.

20. The non-transitory computer-readable medium of claim 19, wherein the at least one network device has a plurality of indicator lights, wherein the visual guides comprise a set of consecutive numbers, wherein each consecutive number is located proximate one indicator light in the modified image, and wherein the troubleshooting query comprises at least one position encoded question concerning the plurality of indicator lights.
